(19) United States
(12) Patent Application Publication
(10) Pub. No.: US 2012/0110789 A1
(43) Pub. Date: May 10, 2012

(54) METHOD FOR PREPARING A SUSPENSION

(75) Inventors: Peter Kaniut, Amberg (DE); Georg Fritsch, Schwarzach (DE)

(73) Assignees: SIC PROCESSING AG, Hirschau (DE); AKW APPARATE + VERFAHREN GMBH, Hirschau (DE)

(21) Appl. No.: 13/382,799

(22) PCT Filed: Jun. 30, 2010
(86) PCT No.: PCT/EP2010/059259

§ 371 Date: Jan. 19, 2012

(30) Foreign Application Priority Data
Jul. 9, 2009 (DE) 10 2009 032 425.9
Jul. 28, 2009 (DE) 10 2009 034 949.9

(51) Int. Cl. B01D 3/00; B01D 21/26

(52) U.S. Cl. 23/293 R; 202/163

(57) ABSTRACT

A method for preparing a suspension from a separation process, wherein the suspension is made of a particulate abrasive and a liquid slurrying agent. The method includes the steps of: a) thinning the suspension in a tank with an additional slurrying agent (PEG) without adding additional water, producing a constant volume ratio between the particulate abrasive and the liquid slurrying agent; b) separating the thinned suspension into a liquid and a solid fraction in a centrifugal separator, and c) subsequent refinement or reuse of the separated liquid and solid fractions.

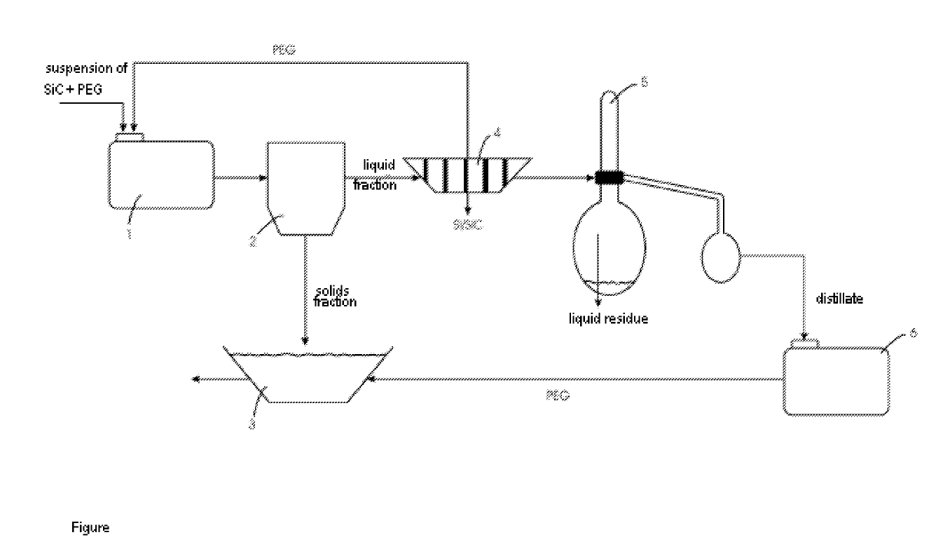

The invention relates to a process for working up a suspension from a parting process, where the suspension consists of a particulate abrasive and a liquid slurrying medium, according to the combination of features in claim 1.

The parting of cylindrical silicon ingots to produce wafers is carried out, for example, by means of a wire saw, usually using an additional abrasive. Such an abrasive can be, for example, silicon carbide slurried in a suitable medium.

After the sawing process is complete, the abrasive, the slurrying medium and silicon particles separated off by the cutting process are consequently present as waste products.

Since these waste products are very valuable raw materials, processes and corresponding plants have for a long time been made available for separating, purifying and reusing the used abrasive and the used slurrying medium.

Such a process is described, for example, in DE 699 04 986 T2. In the method described there for separating and recovering polyethylene glycol and silicon carbide abrasive, a wet powder agglomerate consisting of silicon carbide particles and silicon powder is firstly diluted by addition of water. This is followed by an aqueous slurry of the available abrasive particles and an aqueous slurry containing the silicon particles being separated off. Subsequently, the slurry of the abrasive particles is dried in an oven for recovery and reuse. Furthermore, the aqueous slurry of silicon powder is filtered to recover the silicon powder for subsequent drying.

In addition, the used abrasive liquid is heated before the water dilution step in order to reduce its viscosity. A further aspect of the teaching there provides for the used heated liquid having a low viscosity to be filtered in order to recover firstly the wet powder agglomerate and secondly the slurrying medium containing silicon particles.

This is followed by the slurrying medium being separated off for recovery and traces of silicon particles still present being separated off and subsequently being able to be disposed of or optionally reused.

The total process is thus based on the initial dilution of the silicon carbide particles and the silicon powder by addition of relatively large amounts of water.

However, the use of water in such a work-up process is associated with a number of disadvantages.

Firstly, the water usage represents a significant cost factor, with the costs resulting from procurement of water, purification of the water and disposal. Secondly, the introduction of water into a work-up process of used sawing suspension involves considerable hazards. On coming together, water and silicon generally undergo an exothermic reaction. The hydrogen production associated with the exothermic reaction incurs the risk of sudden ignition of solids fractions which have been separated off. Spontaneous ignition of Big Bags (storage containers) sometimes follows.

In the light of the above, it is an object of the present invention to provide a process for working up a suspension of the type mentioned above, which process can firstly be employed more simply and cheaply and secondly satisfies all safety requirements.

The object of the invention is achieved by a process for working up a suspension from a parting process according to the teaching of claim 1, with the dependent claims representing at least advantageous embodiments and further developments.

The suspension consists of a particulate abrasive and a liquid slurrying medium, and the following steps are carried out for working up this suspension:

Firstly, the suspension is diluted with additional slurrying medium in a tank. The additional addition of water is explicitly omitted in this dilution. In addition, a constant volume ratio of the particulate abrasive to the liquid slurrying medium is established.

The volume ratio of the particulate abrasive to the slurrying medium after dilution is in the range from 1:1 to 1:10. The volume ratio is preferably 1:5.

The diluted suspension is subsequently introduced into a separator, in particular a centrifugal separator, which effects separation of the diluted suspension into a liquid fraction and a solids fraction.

The liquid and solids fractions which have been separated off can subsequently either be upgraded further in processing operations or are present as reusable materials after this process step.

It may be mentioned that the particulate abrasive is silicon carbide (SiC). The slurrying medium can be polyethylene glycol (PEG).

In addition, the process of the invention provides for the suspension provided with additional slurrying medium to be heated in the tank in order to reduce the viscosity. This heating step can, for example, be carried out at a temperature of about 90° C.

The solids fraction which has been separated off in the centrifugal separator can be reused in this state as slurry batch in a separation process. This is not possible by means of centrifuge processes known hitherto since in these cases after-treatment of the solids fraction separated off is absolutely necessary.

On the other hand, the liquid fraction which has been separated off is subjected to an after-purification. Such an after-purification can, for example, be carried out by means of filtration. In particular, the use of a filter press, possibly with filtration aids, is conceivable.

The liquid fraction which has been purified in this way can be used as slurrying medium and introduced into a circuit of the worked up suspension for dilution in the tank.

In addition, residual particles which can be, for example, silicon (Si) and/or silicon carbide are precipitated in the after-purification of the liquid fraction. The residual particles which have been separated off in this way can be used as semifinished products. This makes reuse of the difficult-to-procure and accordingly expensive silicon possible.

A further aspect of the invention provides for at least part of the after-purified liquid fraction, which corresponds to the liquid component of the working suspension, to be subjected to a distillation. Continuous operation of the plant is thus possible.

Volatile and relatively nonvolatile components can be removed by means of such a distillation.

The distillation is preferably carried out under reduced pressure, in particular at a pressure of about 10⁻² mbar.

The distillate obtained is fed into a tank and is available in this form for further use. For example, the distillate obtained, which is, for example, a PEG product, can be sold or can be mixed into the slurry batch obtained by the separation in the centrifugal separator. This slurry batch can then be used in a subsequent sawing operation.

For example, the process just described is carried out batchwise for working up used suspensions.

In particular, the process of the invention is employed in the production of silicon wafers, i.e. in the cutting of cylindrical silicon ingots into single wafers.

A plant for carrying out the process of the invention comprises essentially a tank for dilution, a centrifugal separator, a filtration unit and a distillation unit. These individual components are preferably accommodated in separate containers so that they can easily be transported to various use sites and assembled.

In addition, such accommodation in containers allows variable selection of the individual assemblies or components. Thus, assemblies or components having different performance features can be selected according to the desired throughput.

The above-described process for working up a suspension from a parting process combines a number of advantages. Firstly, the process presented is simpler to handle and cheaper to implement. Secondly, the omission of additional addition of water enables the risk of sudden ignition of Big Bags resulting from the formation of hydrogen to be ruled out.

In addition, water treatment as is necessary in centrifuge processes known hitherto is not required. In addition, no contaminated wastewater is obtained.

Furthermore, the solids fraction separated off by means of the centrifugal separator contains a smaller proportion of fines compared to known centrifuge processes, as a result of which longer use of the solids fraction compared to conventional centrifuge processes is possible. Furthermore, the liquid fraction which has been separated off does not have to be after-purified in a complicated fashion in a centrifuge, as has hitherto been the case in known centrifuge processes.

The process of the invention for working up a suspension from a parting process will be illustrated below by means of a working example and with the aid of a figure.

The disposition and process scheme shown in the figure for working up a suspension relates in the present case to the work-up of a suspension which is obtained in the production of silicon wafers and consists of particulate abrasives and a liquid slurrying medium. The particulate abrasives are silicon carbides and the slurrying medium is polyethylene glycol.

The suspension is firstly introduced into a tank 1 where it is diluted with additional slurrying medium but not with water. The additional slurrying medium is once again polyethylene glycol. A virtually constant volume ratio of 1:5 is established between the particulate silicon carbides and the liquid polyethylene glycol. To reduce the viscosity further, the suspension provided with additional slurrying medium can be heated in the tank 1.

Since the used suspension can be present in various mixing ratios in respect of the proportions of particulate abrasives in the liquid slurrying medium, a control device is installed in the feed line for the slurrying medium to be introduced into the tank, so that only the amount of liquid slurrying medium required to establish a predetermined volume ratio between the particulate abrasive and the liquid slurrying medium is always fed into the tank.

The diluted suspension which has been heated to reduce the viscosity and is present in the tank 1 is subsequently introduced into a centrifugal separator 2 where the suspension is separated into a liquid fraction and a solids fraction.

The solids fraction separated off contains, inter alia, silicon carbide and a small proportion of the PEG and can thus form a slurry batch as is used during sawing of silicon ingots, with the appropriate use mixture being produced again by addition of purified PEG.

The liquid fraction separated off in the centrifugal separator 2 is subsequently subjected to a purification, for example by use of filters 4. Part of the after-purified liquid fraction (PEG) can then be used as diluent for the suspension in the tank 1. Residual particles containing, inter alia, silicon and silicon carbide particles are collected by the filters 4. The silicon obtained in this way can be used as finished or semifinished product.

The PEG which has been after-purified by means of the filter unit 4 can also be fed to a distillation unit 5 in which volatile and relatively nonvolatile components are removed at very low pressures. The distillation is carried out under reduced pressure, in the present case at a pressure of about 10⁻² mbar. The distillation throughput of the after-purified PEG is, for example, about 250 l/h. The distillate obtained is a high-quality PEG which is preferably dispensed into a tank 6.

The PEG which has been stored in this way is either sold on or used for upgrading of the slurry batch 3 formed by means of the centrifugal separator 2.

The process described comprises operations for working up a suspension from a parting process, which are carried out without additional addition and consequently contamination of water. The individual components of the worked up suspension can be reused to a very large extent, as a result of which only a very small proportion of waste products is ultimately formed. In addition, a significantly better quality of the recovered solid and liquid constituents compared to conventional centrifuge processes is achieved.

### LIST OF REFERENCE NUMERALS

1 tank
2 centrifugal separator
3 slurry batch
4 filter/filter unit
5 distillation unit
6 PEG tank

1. A process for working up a suspension from a parting process, where the suspension consists of a particulate abrasive and a liquid slurrying medium, which comprises the steps:
a) dilution of the suspension with additional slurrying medium in a tank without additional addition of water and with establishment of a constant volume ratio between the particulate abrasive and the liquid slurrying medium;
b) separation of the diluted suspension into a liquid fraction and a solids fraction in a centrifugal separator, where the liquid fraction separated off in the centrifugal separator is subjected to an after-purification effected by means of at least one filter and
c) subsequent upgrading or reuse of the separated liquid fraction and solids fraction.

2. The process as claimed in claim 1, wherein the particulate abrasives are silicon carbide (SiC).

3. The process as claimed in claim 1, wherein the slurrying medium is polyethylene glycol (PEG).

4. The process as claimed in claim 1, wherein the suspension provided with additional slurrying medium is heated in the tank to reduce the viscosity.

5. The process as claimed in claim 1, wherein the volume ratio of the particulate abrasive to the slurrying medium after dilution is in the range from 1:1 to 1:10.

6. The process as claimed in claim 5, wherein the volume ratio of the particulate abrasive to the slurrying medium after dilution is about 1:5.

7. The process as claimed in claim 1, wherein the after-purified liquid fraction is used as slurrying medium and is introduced to effect dilution into a circuit of the suspension to be worked up.

8. The process as claimed in claim 1, wherein residual particles are precipitated in the after-purification of the liquid fraction and the precipitated residual particles are used as semifinished products.

9. The process as claimed in claim 8, characterized in that wherein the precipitated residual particles are silicon (Si) and/or silicon carbide (SiC).

10. The process as claimed in claim 1, wherein the after-purified liquid fraction is subjected to a distillation.

11. The process as claimed in claim 10, wherein the distillation is carried out under reduced pressure.

12. The process as claimed in claim 10, the distillation is carried out at a pressure of about 10-2 mbar.

13. The process as claimed in claim 10, the distillation throughput of the after-purified liquid fraction is from about 200 to 300 l/h.

14. The process as claimed in claim 10, wherein the distillate obtained is introduced into a further tank.

15. The process as claimed in claim 1, wherein the solids fraction separated off in the separator is used as slurry batch.

16. The process as claimed in claim 10, wherein the slurry batch is mixed with the after-purified and distilled liquid fraction.

17. The process as claimed in claim 1, wherein the process for working up used suspension is carried out batchwise.

18. The process as claimed in claim 1, wherein the process for working up used suspension is carried out continuously.

19. The use of the process as claimed in claim 1, wherein in the production of silicon wafers by sawing from an ingot.

20. A plant for carrying out the process as claimed in claim 1, wherein the individual components or assemblies such as the tank for dilution, the in particular centrifugal separator, the filter unit and the distillation unit are accommodated in separate containers in order to ensure easy assembly and use in various places.
